(19) United States
(12) Patent Application Publication
(10) Pub. No.: US 2018/0106410 A1
(43) Pub. Date: Apr. 19, 2018

(54) P-TRAP DEVICE AND METHOD

(71) Applicant: Dave Chambers, Mableton, GA (US)

(72) Inventor: Dave Chambers, Mableton, GA (US)

(21) Appl. No.: 15/786,568

(22) Filed: Oct. 17, 2017

Related U.S. Application Data
(60) Provisional application No. 62/408,956, filed on Oct. 17, 2016.

(51) Int. Cl. F16L 45/00; E03C 1/284; E03C 1/302

(52) U.S. Cl. CPC F16L 45/00; E03C 1/302; E03C 1/284

(57) ABSTRACT

A p-trap device including body assembly, a door assembly, and a cleanout-tool; the body assembly includes an inlet, an outlet, an upper-dip, and a lower-dip. The door assembly includes a door and a base, with the door assembly coupled to the lower-dip of the body assembly and configured to provide access for maintenance to the p-trap device and provide a means for draining the body assembly of the p-trap device when the door is in an open position. The door is coupled to the base via a hinge. The cleanout-tool is included and configured to remove debris from the p-trap device when the door is in an open position, with the cleanout-tool attachable to the p-trap device.

### CROSS-REFERENCE TO RELATED APPLICATION(S)

The present application is related to and claims priority to U.S. Provisional Patent Application No. 62/408,956 filed Oct. 17, 2016, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of fluid handling of existing art and more specifically relates to efficient fluid handling means.

### RELATED ART

In plumbing applications, a trap is a device that includes a shape that is constructed with a bending path to maintain water in order to prevent sewer gases from entering buildings, while allowing waste to pass through. In domestic applications, the traps are generally referred to as “p-traps”, although other shapes and nomenclature can be used. Most all plumbing fixtures (e.g., sinks, bathtubs, toilets, etc.) must be equipped with either an internal or external trap by local codes. Due it is a localized low-point in the plumbing, p-traps tend collect hair, debris, and grow mold or algae which may limit the flow area of the pipe. In cases where objects are inadvertently dropped down the sink the p-trap may (very seldom) capture the item. Most often the item is flushed into the general water system. In an effort to retrieve an item inadvertently dropped into the drain or remove unwanted debris/blockage, the p-trap must be removed from the plumbing system; causing significant time, energy, and/or cost to employ a plumber. Therefore a suitable solution is desired.

U.S. Pat. No. 6,915,814 to Dara Cheng relates to a transparent pipe trap with a means of enhancing biodegration of sink effluents. The described transparent pipe trap with means of enhancing biodegration of sink effluents includes a transparent pipe trap with means of enhancing the biodegradation of sink effluents in a household sink which uses a screen located “downstream” from the trap to deflect valuable items into the trap. The trap is easily drained and easily removed, for convenient retrieval of valuable items, such as rings, which are lost down a sink or other drain. The invention also promotes the biodegradation of sink effluents through time-release biodegradation substances in the cup and/or coated upon the screen.

### SUMMARY OF THE INVENTION

In view of the foregoing disadvantages inherent in the known fluid handling with access opening art, the present disclosure provides a novel p-trap device and method. The general purpose of the present disclosure, which will be described subsequently in greater detail, is to provide an efficient and effective readily-accessible p-trap device and method.

A novel p-trap device is disclosed herein. The p-trap device includes a body assembly, a door assembly, and a cleanout-tool. The body assembly includes an inlet, an outlet, an upper-dip, and a lower-dip. The door assembly includes a door and a base, with the door assembly coupled to the lower-dip of the body assembly and configured to provide access for maintenance to the p-trap device and provide a means for draining the body assembly of the p-trap when the door is in an open position. The door is preferably coupled to the base via a hinge.

The cleanout-tool is configured to remove debris from the p-trap device when the door is in an open position, with the cleanout-tool attachable to the p-trap device. Also, when the door is in the open position, the door will be arranged in a plane that is substantially parallel to the body assembly. In order to maintain the door assembly in the closed position, a threaded-fastener is used to secure the door. Also, the door assembly may include a gasket to provide a water-tight seal between the door and the base. The gasket may be removable and replaceable.

Preferably, the p-trap device is constructed from a durable plastic material such that the device is corrosion resistant and the body assembly is tubular in shape. Also, the upper-dip is located above the lower-dip on a circumference of the body assembly of the p-trap device.

The body assembly is configured to hold and maintain a volume of water such that air may not freely pass through the body assembly, therefore eliminating drainage/sewer gasses from entering. The inlet of the p-trap device is removably coupleable to a plumbing fixture and the outlet is removably coupleable to a plumbing drain-line.

According to another embodiment, a method of use for a p-trap device is also disclosed herein. The method of use for a p-trap device includes a first step, providing a p-trap device (the p-trap device including a body assembly and a door assembly, the door assembly including a base and a door); a second step, affixing the p-trap device to a plumbing system; a third step, opening the door of the p-trap device; a fourth step, removing one or more objects from the p-trap device; and a fifth step, closing the door of the p-trap device.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a p-trap device and method, constructed and operative according to the teachings of the present disclosure.

FIG. 1 is a perspective view of the p-trap device during an ‘in-use’ condition, according to an embodiment of the disclosure.

FIG. 2 is a perspective view of the p-trap device of FIG. 1, according to an embodiment of the present disclosure.

FIG. 3 is a perspective view of the p-trap device of FIG. 1, according to an embodiment of the present disclosure.

FIG. 4 is a perspective view of the p-trap device of FIG. 1, according to an embodiment of the present disclosure.

FIG. 5 is a flow diagram illustrating a method of use for the p-trap device, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a fluid handling with access opening device and more particularly to a p-trap device and method as used to improve the efficiency of a user to clean a p-trap and/or remove items that have been inadvertently dropped down a drain system.

Generally, the p-trap device allows an individual/user to replace an existing drain pipe with this novel invention, which gives the user an ability to recover items and/or unclog pipes without having to employ a plumber or remove piping. The device serves dual purposes; it allows a user to retrieve items, but also allows a user to have better access to unclog blockages in the pipe without having to remove the pipe, therefore saving time and expenses. This p-trap device extends the bottom area of the pipe such that it has a large trap to catch objects. The trap is also deep so it may catch anything inadvertently dropped in the drain.

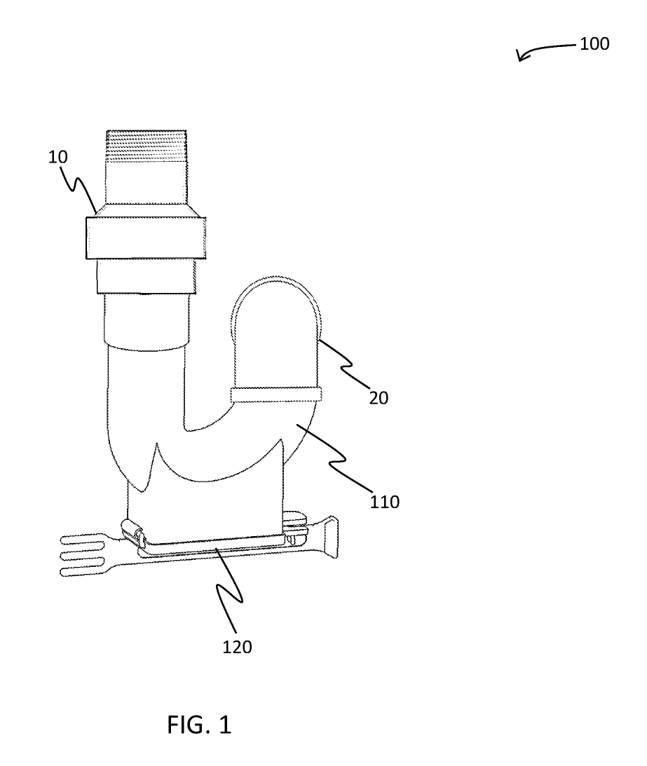

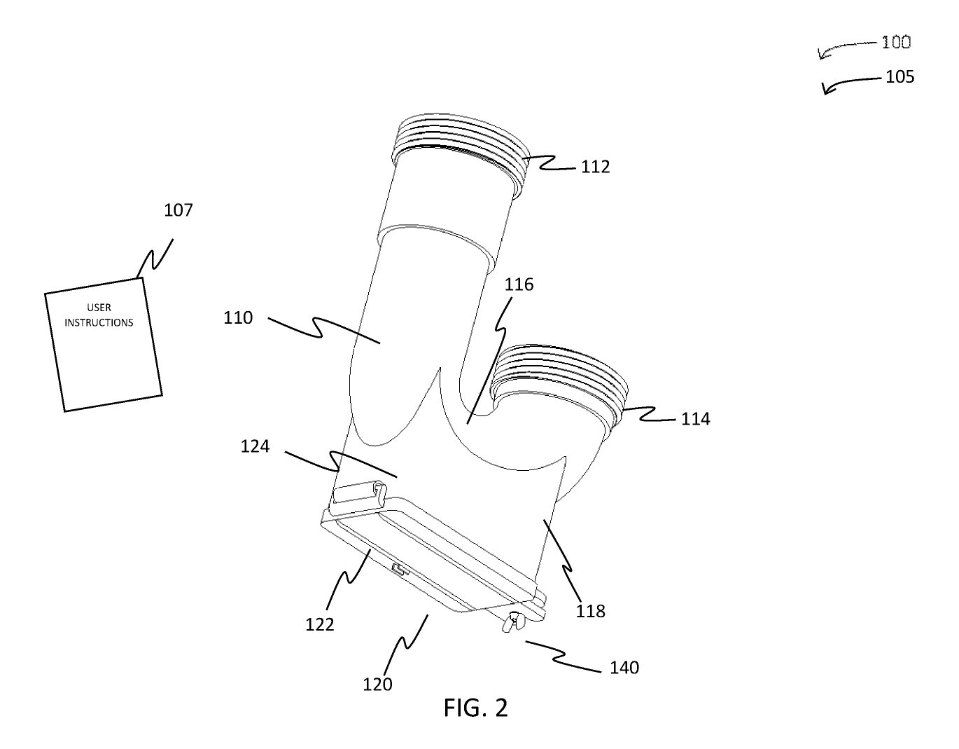

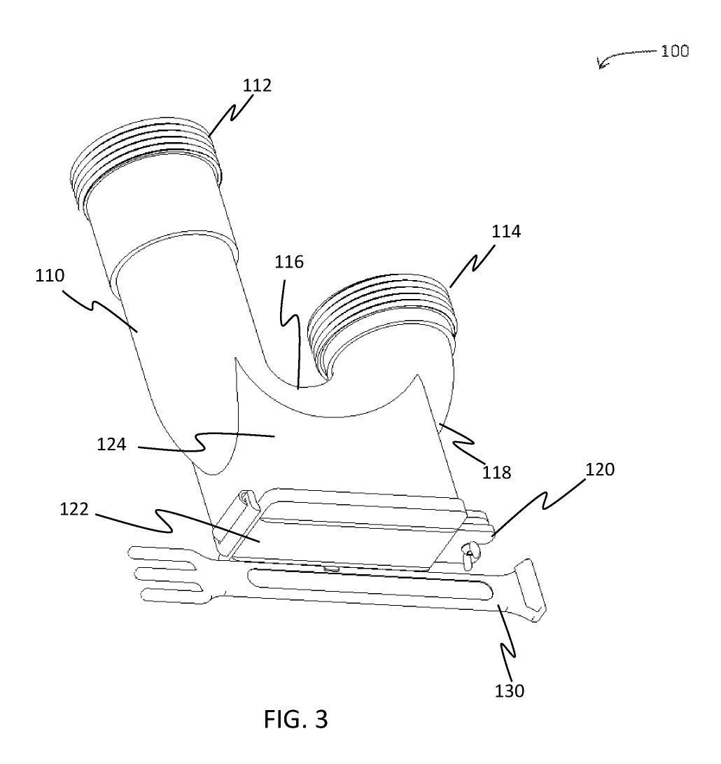

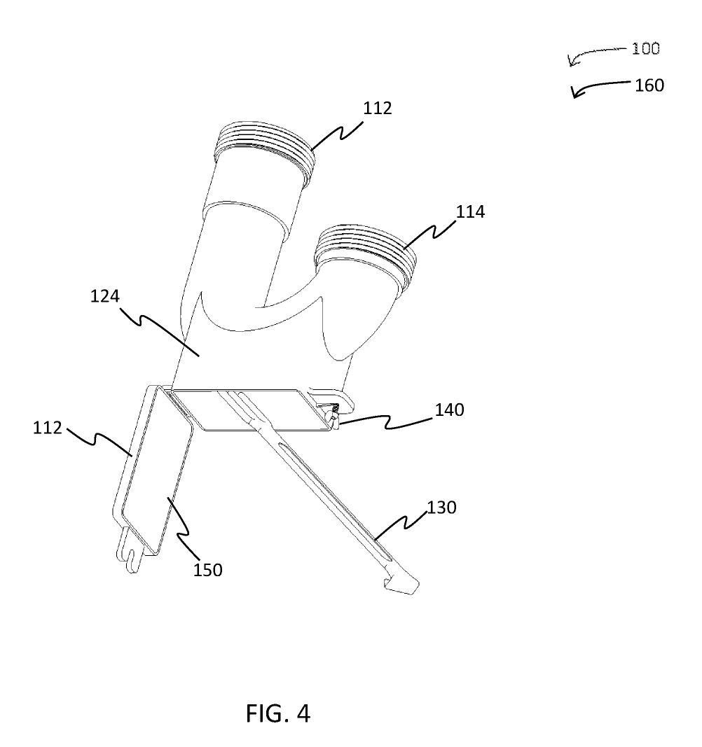

Referring now more specifically to the drawings by numerals of reference, there is shown in FIGS. 1-4, various views of a p-trap device 100.

FIG. 1 shows p-trap device 100 during an ‘in-use’ condition 50, according to an embodiment of the present disclosure. Here, p-trap device 100 may be beneficial for use by a user to allow the user to remove items from a drain line 20 without the need to remove the drain pipe itself. As illustrated, the p-trap device 100 may include body assembly 110 and door assembly 120.

As shown in FIGS. 1-4, body assembly 110 may include inlet 112, outlet 114, upper-dip 116, and lower-dip 118; and body assembly 110 may be tubular in shape 110. Upper-dip 116 may located above lower-dip 118 on a circumference of body assembly 110 (some specific applications may require alternate arrangements). Door assembly 120 may include door 122 and base 124, with door assembly 120 coupled to lower-dip 118 of body assembly 110 and configured to provide access for maintenance to p-trap device 100 and provide a means for draining body assembly 110 of p-trap device 100 when door 122 is in an open position 160.

Body assembly 110 may be configured to hold and maintain a body of water such that air may not freely pass through body assembly 110. Also, inlet 112 may be removably coupleable to plumbing fixture 10 (e.g., sink, bathtub, shower, etc.) and outlet 114 may be removably coupleable to plumbing drain-line 20.

According to one embodiment, p-trap device 100 may be arranged as a kit 105. In particular, p-trap device 100 may further include a set of instructions 107. The instructions 107 may detail functional relationships in relation to the structure of the p-trap device 100 such that the p-trap device 100 can be used, maintained, or the like, in a preferred manner.

In embodiments, door 122 may be hingedly coupled to base 124. Also, door assembly 120 may include threaded-fastener 140 to maintain door 122 in a closed position, in some embodiments. Other embodiments may include door assembly 120 which includes a clip, clasp or the like to maintain door 122 in a closed position. Further, door assembly 120 may include gasket 150 to provide a water-tight seal between door 122 and base 124, where gasket 150 may be constructed from an anti-fungal and anti-bacterial material as well as being removable and replaceable.

P-trap device 100 may also include cleanout-tool 130, with cleanout-tool 130 configured to remove debris from p-trap device 100 when door 122 is in open position 160. Additionally, embodiments may include cleanout-tool 130 configured to be attachable to p-trap device 100 for ease of storage of cleanout-tool 130.

Door 122 of p-trap device 100 may be constructed from a variety of materials. For example, door 122 (and/or other components) may be magnetic in some embodiments and p-trap device 100 may be constructed from a metallic material for durability and longevity during use, or may be constructed from a durable plastic material for corrosion resistance. Other materials may be used (e.g., ceramics, composites, glass, etc.). Body assembly 110 of p-trap device 100 may be constructed from a clear material such that a user may view the contents within body assembly 110. Similarly, door assembly 120 may be constructed from a clear material such that a user may view the contents within door assembly 120.

The arrangement of door 122 in relation to body assembly 110 may vary in certain embodiments. For example door 122, when in open position 160, may lie in a plane that is substantially parallel to body assembly 110. Also door 122, when in open position 160, may be arranged in a plane that is substantially perpendicular to body assembly 110.

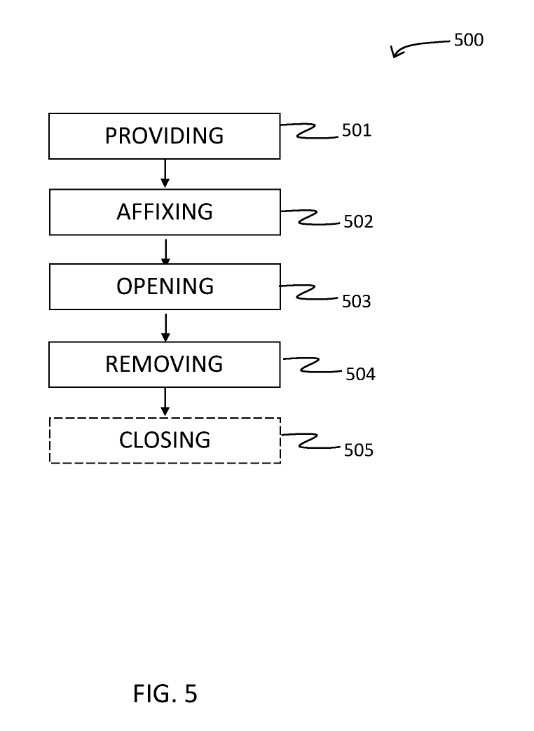

FIG. 5 is a flow diagram illustrating a method of use 500 for p-trap device 100, according to an embodiment of the present disclosure. In particular, method of use 500 for a p-trap device 100 may include one or more components or features of the p-trap device 100 as described above. As illustrated, method of use 500 for a p-trap device 100 may include the steps of: step one 501, providing p-trap device 100 (p-trap device may include body assembly 110 and door assembly 120; door assembly may include base 124 and door 122); step two 502, affixing p-trap device 100 to a plumbing system; step three 503, opening door of p-trap device 100; step four 504, removing one or more objects from p-trap device 100; and step five 505, closing door 122 of p-trap device 100.

It should be noted that step five 505 is an optional step and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods of use for p-trap device 500 [NOTE: e.g., different step orders within above-mentioned list, elimination or addition of certain steps, including or excluding certain maintenance steps, etc.], are taught herein. Those with ordinary skill in the art will now appreciate that upon reading this specification and by their understanding the art of plumbing as described herein, methods of installation, use, maintenance, and structure will be understood by those knowledgeable in such art.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A p-trap device, the p-trap device comprising:
a body assembly, said body assembly including an inlet, an outlet, an upper-dip, and a lower-dip; and
a door assembly, said door assembly including a door and a base, said door assembly coupled to said lower-dip of said body assembly configured to provide access for maintenance to said p-trap device and provide a means for draining said body assembly of said p-trap when said door is in an open position;
wherein said body assembly is tubular in shape;
wherein said upper-dip is located above said lower-dip on a circumference of said body assembly;
wherein said body assembly is configured to hold and maintain a body of water such that air may not freely pass through said body assembly;
wherein said inlet is removably coupleable to a plumbing fixture; and
wherein said outlet is removably coupleable to a plumbing drain-line.

2. The device of claim 1, wherein said door is hingedly coupled to said base.

3. The device of claim 1, wherein said p-trap device further includes a cleanout-tool configured to remove debris from said p-trap device when said door is in said open position.

4. The device of claim 3, wherein said cleanout-tool is configured to be attachable to said p-trap device.

5. The device of claim 1, wherein said door assembly includes a threaded-fastener to maintain said door in a closed position.

6. The device of claim 1, wherein said door assembly includes a clip to maintain said door in said closed position.

7. The device of claim 1, wherein said door assembly further includes a gasket to provide a water-tight seal between said door and said base.

8. The device of claim 7, wherein said gasket is constructed from an anti-fungal and anti-bacterial material.

9. The device of claim 1, wherein said gasket is removable and replaceable.

10. The device of claim 1, wherein said door is magnetic.

11. The device of claim 1, wherein said door, when in said open position, lies in a plane that is substantially parallel to said body assembly.

12. The device of claim 1, wherein said door, when in said open position, lies in a plane that is substantially perpendicular to said body assembly.

13. The device of claim 1, wherein said body assembly is constructed from a clear material such that a user may view contents within the body assembly.

14. The device of claim 1, wherein said door assembly is constructed from a clear material such that a user may view the contents within the door assembly.

15. The device of claim 1, wherein said device is constructed from a metallic material for durability and longevity during use.

16. The device of claim 1, wherein said device is constructed from a durable plastic material to be corrosion resistant.

17. A p-trap device, the p-trap device comprising:
a body assembly, said body assembly including an inlet, an outlet, an upper-dip, and a lower-dip; and
a door assembly, said door assembly including a door and a base, said door assembly coupled to said lower-dip of said body assembly configured to provide access for maintenance to said p-trap device and provide a means for draining said body assembly of said p-trap when said door is in an open position; and
a cleanout-tool configured to remove debris from said p-trap device when said door is in said open position;
wherein said door, when in said open position, lies in a plane that is substantially parallel to said body assembly;
wherein said device is constructed from a durable plastic material to be corrosion resistant;
wherein said door assembly includes a threaded-fastener to maintain said door in a closed position;
wherein said cleanout-tool is configured to be attachable to said p-trap device;
wherein said body assembly is tubular in shape;
wherein said door assembly further includes a gasket to provide a water-tight seal between said door and said base
wherein said upper-dip is located above said lower-dip on a circumference of said body assembly;
wherein said body assembly is configured to hold and maintain a body of water such that air may not freely pass through said body assembly;
wherein said inlet is removably coupleable to a plumbing fixture;
wherein said outlet is removably coupleable to a plumbing drain-line; and
wherein said door is hingedly coupled to said base.

18. The device of claim 17, further comprising set of instructions; and
wherein the device is arranged as a kit.

19. A method of use for a p-trap device, the method comprising the steps of:
providing a p-trap device, said p-trap device including a body assembly and a door assembly, said door assembly including a base and a door;
affixing said p-trap device to a plumbing system;
opening said door of said p-trap device; and
removing one or more objects from said p-trap device.

20. The method of claim 19, further comprising the steps of:
closing said door of said p-trap device.
